(19) United States
(12) Patent Application Publication
(10) Pub. No.: US 2013/0076667 A1
(43) Pub. Date: Mar. 28, 2013

(54) TOUCH PANEL AND A MANUFACTURING METHOD THEREOF

(71) Applicants: YAU-CHEN JIANG, Zhubei City (TW); Yanjun Xie, Wuhan City (TW); Fangyi Chen, Wenxie City (TW)

(72) Inventors: YAU-CHEN JIANG, Zhubei City (TW); Yanjun Xie, Wuhan City (TW); Fangyi Chen, Wenxie City (TW)

(21) Appl. No.: 13/536,975

(22) Filed: Jun. 28, 2012

(30) Foreign Application Priority Data
Sep. 23, 2011 (CN) 201110305252.1

(51) Int. Cl. G06F 3/041; G06F 1/16

(52) U.S. Cl. 345/173; 29/428

(57) ABSTRACT

The present disclosure relates to a touch technology, more particularly to a touch panel and a manufacturing method thereof. The touch panel comprises a touch area and a peripheral area. The touch panel further comprises: at least one peripheral line, each of which has a stacking structure and is disposed in the peripheral area surrounding the touch area for transmitting touch signals generated by the touch area. The stacking structure of each peripheral line improves stability of the touch signals transmission in the touch panel.

This application claims the benefit of Chinese application No. 201110305252.1 , filed on Sep. 23, 2011.

### BACKGROUND OF THE INVENTION

1. Field of the Invention

The present disclosure relates to touch technology, more particularly to a touch panel and a manufacturing method thereof.

2. Description of the Related Art

In the current consumer electronic, product market, integrating touch function with display has become a mainstream trend for the development of portable electronic products. The touch display panels have been applied to many electronic products, including smart phones, mobile phones, tablet PCs and notebooks. Since a user can, in such products, operate directly through objects displayed on display and order instructions, the touch screen panels serve as an interface between the user and the electronic, products.

Conventional touch panel technologies usually include resistive, capacitive, and fluctuating technologies etc. The touch panels usually comprise a touch area, and a peripheral area surrounding the touch area. The touch area is used for generating touch signals, and a plurality of peripheral lines are disposed at interior sides of the peripheral area, which are used for transmitting the touch signals to a controller to determine coordinates of the touch location.

However, in the conventional touch panel structures, peripheral lines usually are single-layer structures and are made of metal materials. Therefore, if the peripheral lines are exposed to external knocks or erosion from outside environment, they get disconnected easily, as a result of which some of the touch area signals are not appropriately transmitted to the controller for conducting subsequent touch position operations.

### SUMMARY OF THE INVENTION

An objective of the present disclosure is to provide a touch panel and a manufacturing method thereof which adopts peripheral lines with a stacking structure to improve stability of transmitting touch signals in the touch panel.

The present disclosure provides a touch panel which has a touch area and a peripheral area, comprising: at least one peripheral line, each of which has a stacking structure and is disposed in the peripheral area surrounding the touch area for transmitting touch signals generated by the touch area.

The present disclosure further provides a manufacturing method of a touch panel comprising a touch area and a peripheral area, the method comprising: forming at least a peripheral line, each of which has a stacking structure and is disposed in the peripheral area surrounding the touch area for transmitting the touch signals generated by the touch area.

The touch panel and the manufacturing method of a touch panel provided in the present disclosure adopt peripheral lines with a stacking structure. When the superstructure (or the understructure) of the peripheral lines in the touch panel are subjected to external knocks or erosion from outside environment, touch signals of the touch panel are transferred to a controller through the understructure (or the superstructure) of the peripheral lines for calculating subsequent touch position operation, and thereby enhancing stability of touch signal transmission.

### BRIEF DESCRIPTION OF THE DRAWINGS

For those skilled in the art o understand this disclosure, numerous embodiments combined with drawings described below are for illustration purpose only and do not limit the scope of the present disclosure in any manner.

FIG. 1 and FIG. 2 are flow charts of a manufacturing method of a touch panel in accordance with an embodiment of the present disclosure; and

FIG. 3 is a schematic diagram of a cross-sectional structure of the peripheral lines along tangent lines A-A′ in FIG. 2;

It would be understood that all the schemas disclosed herein are only by way of representation. In order to attain the interpretation objective, dimensions and proportions of components drawn in the schema may be amplified or reduced. In the different embodiments, the same component symbols can be used for representing corresponding or similar characters.

### DETAILED DESCRIPTION OF THE EMBODIMENTS

In the following embodiments, capacitive touch panel technology is taken by way of illustration. However, spirit of the present disclosure can be extended to other touch panel technologies and not limited to resistive type, infrared type and surface acoustic wave type, etc.

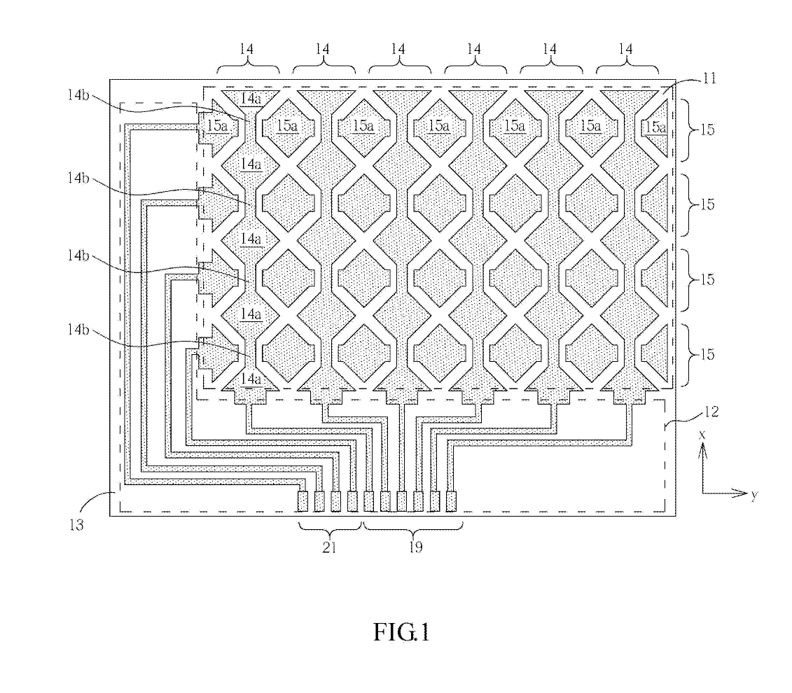

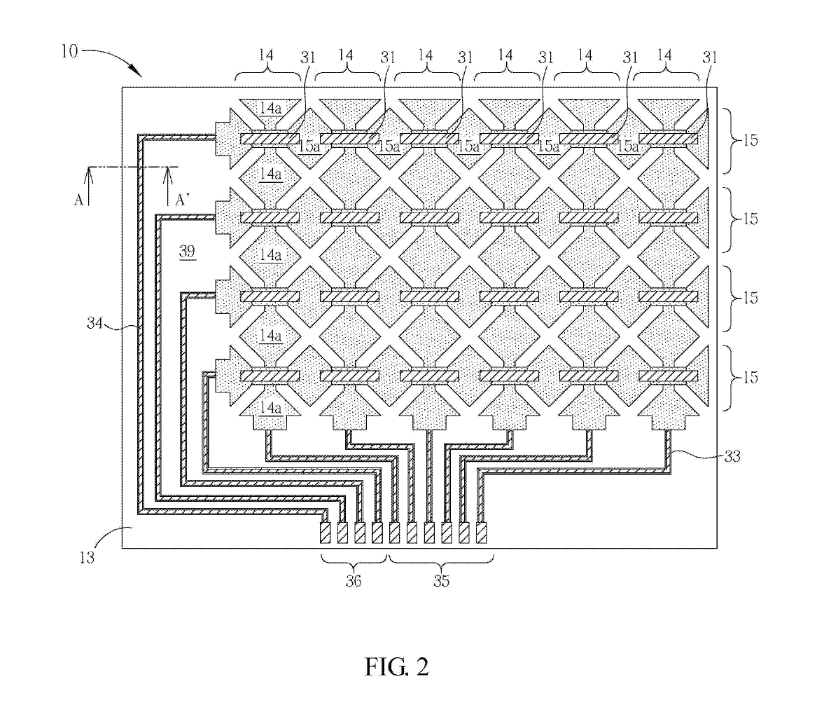

FIG. 1 and FIG. 2 are the flow charts of a manufacturing method of a touch panel in accordance with an embodiment of the present disclosure. As shown in FIG. 1, firstly, a transparent substrate 13 is provided. The transparent substrate 13 comprises a touch area 11 and a peripheral area 12, wherein the touch area 11 is a major sensing area, and the peripheral area 12 is an area for disposing peripheral lines 35 and 36. The transparent substrate 13 is a hard substrate such as a glass substrate, or any other flexible substrate selected from a group comprising polycarbonate (PC), polyethylene terephthalate (PET), polymethylmesacrylate (PMMA), Polysulfone (PES) and other cyclic olefin copolymers.

Understructures 19 and 21 in the peripheral area 12, first axial electrodes 14 and second axial electrodes 15 in the touch area 11, are formed subsequently. In the present embodiment, a transparent conductive layer (not shown) can first be formed on a surface of the transparent substrate 13. The transparent conductive layer comprises indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium gallium magnesium oxide (InGaMgO) or indium gallium aluminum oxide (InGaAlO). Next, etching of the transparent conductive layer on the substrate 13 takes place to form desired patterns on the touch area 11 and the peripheral area 12. As shown in FIG. 1, the first axial electrode 14 extends along a first direction X in the touch area 11, and the second axial electrode 15 extends along a second direction Y, wherein the first axial electrodes 14 comprise a plurality of first sensing units 14a and a plurality of first conductive lines 14b connected to the first sensing units 14a. The second axial electrodes 15 comprise a plurality of second sensing units 15a. It would be noted that, in accordance with an embodiment of the present disclosure, the first axial electrodes 14, the second axial electrodes 15, and the plurality of the understructures 19 and 21 can be formed in the peripheral area 12 simultaneously. The understructures 19 and 21 are electrically connected to the corresponding first axial electrodes 14 and the corresponding second axial electrodes 15, wherein the understructures 19 and 21 serve as one portion of the stacking structure in peripheral lines 35 and 36. Therefore, the understructures 19 and 21, which are situated on the same plane and have same composite materials, are formed in the same etching manufacturing process as the first axial electrodes 14 and the second axial electrodes 15. However, in accordance with another embodiment of the present disclosure, the first axial electrodes 14 and the second axial electrodes 15 can be formed first and then the plurality of the understructures 19 and 21 can be formed, or vice versa. It would be noted that the method of forming the first axial electrodes 14, the second axial electrodes 15, and the understructures 19 and 21 can use the etching manufacturing process which can further employ sputtering, depositing, laser incising, or screen-printing. However, other known methods for forming the electrodes and understructures can also be used.

Referring to FIG. 2, insulation blocks 37, second conductive line 31, superstructures 33-34, and cover layer 39 are formed subsequently.

As shown in FIG. 2, first, a plurality of insulation blocks 37 are formed between first conductive line 14b and the second conductive line 31, the objective of which is to electrically insulate the first axial electrodes 14 and the second axial electrodes 15, wherein the insulation blocks 37 can include multi-layered polymer resin films of high transmittance or inorganic materials, which satisfy the demand of electric insulation and high transmittance simultaneously. Next, by taking advantage of electroplating, non-electroplating, screen printing or any other manufacturing process capable of reaching the same efficiency, the second conductive lines 31 on the corresponding insulation blocks 37 are formed. The second conductive lines 31 can be made of either one metal or a combination of metallic materials such as gold, silver, copper, aluminum or molybdenum. The superstructures 33 and 34 on the surface of the understructures 19 and 21 are formed simultaneously with the second conductive lines 31. The second conductive line 31 is electrically connected to the corresponding second sensing units 15a so as to align the plurality of the second sensing units 15a with the second axial electrodes 15 and electrically connect to each other. In addition, under the premise of not influencing the transmittance, the second conductive lines 31 have relatively broad contact terminal which assists contact area between the second conductive lines 31 and the second axial sensing unit 15a. Therefore, the superstructures 33 and 34 and the understructures 19 and 21 respectively constitute at least one first peripheral line 35 with the stacking structure and at least one second peripheral line 36 with the stacking structure. In accordance with the above description, the first peripheral line 35 and the second peripheral line 36 are in electrical connection between the corresponding first axial electrodes 14 and between the corresponding second axial electrodes 15 so as to transfer the touch signals of the touch area to an external circuit so that the controller can conduct subsequent touch position operations.

It is noticed that in accordance with the embodiment, the second conductive lines 31 and the superstructures 33 and 34 can be formed simultaneously through the same manufacturing process. However, according to another preferred embodiment, the second conductive lines 31 are formed first and then the superstructures 33 and 34 are formed, or vice versa. Therefore, by means of different manufacturing process, the second conductive line 31 and the superstructures 33 and 34 may or may not contain different composite materials, illustratively, the superstructures 33 and 34, besides being composed of metal materials, can also be made up of inorganic conductive materials with low-resistances.

Next, a cover layer 39 is formed on the transparent substrate 13, which aims to protect various components within the touch area 11 and the peripheral area 12 from being subjected to chemical erosion or physical damage. The cover layer 39 can be made of inorganic materials such as silicon nitride, silicon oxide and silicon oxynitride, organic materials such as acrylic resin or other suitable materials.

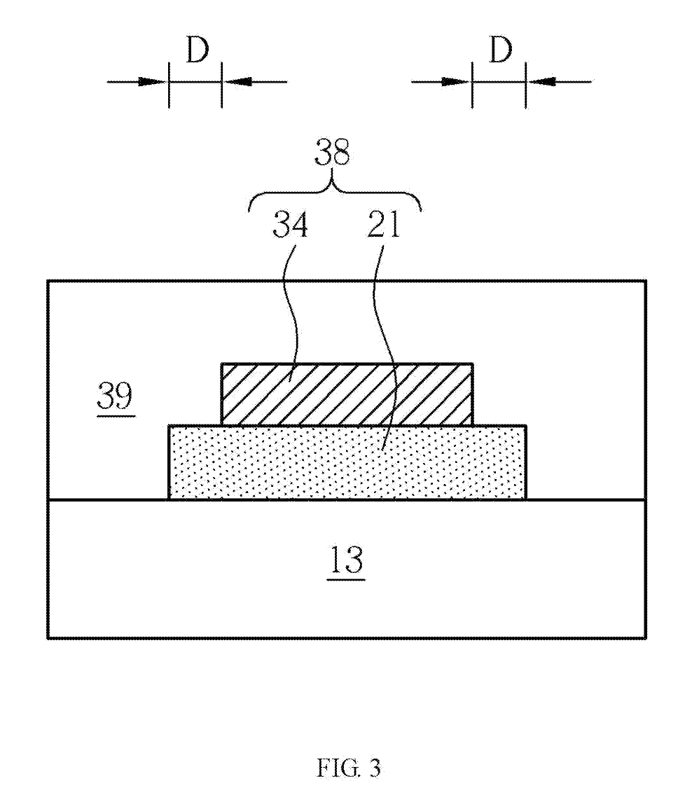

FIG. 3 shows a schematic diagram of a cross-sectional structure of the peripheral lines along tangent lines A-A′ in FIG. 2. According to FIG. 3, the peripheral lines have a stacking structure 38 comprising an understructure 21 and a superstructure 34. The cover layer 39 coats the understructure 21 and the superstructure 34 integrally. As shown in FIG. 3, the short axial width of the superstructure 34 is narrower than the short axial width of the understructure 21. In accordance with an embodiment of the present disclosure, the short axial side of the superstructure 34 and the short axial side of the corresponding understructure 21 is spaced with an interval D, the value of which is preferably 3-5 μm. By means of the foregoing stacking structure, an electrostatic shielding effect can be generated, that is, the electrostatic charges can diffuse through the understructure 21 so as to promote reliability of the touch panels. It would be noted that the stacking construction 38, having a multi-layered superstructure (not shown), can either be composed of metal materials, or inorganic conductive materials with low-resistance. In addition, compositions of the multi-layered superstructures in the same stacking construction 38 may differ from each other. It must be emphasized that the foregoing touch panel, which is not limited to the capacitive touch panel, can comprise capacitive, resistive, infrared ray, acoustic or optical touch panels, with the peripheral lines having foregoing stacking structure 38.

In accordance with the foregoing statements, the disclosure provides a touch panel 10 with the peripheral lines 35 and 36, both having a stacking structure 38 comprising understructures 19 and 21 and at least one superstructure 33 and 34, wherein width of superstructures 33, 34 is less than that of the understructures 19 and 21. The stacking structures 38, even if the superstructures 33 and 34 are subjected to external knocks or erosion of outside environment which results in circuit disconnection, allow the touch signals of the touch area 11 to be transferred to the outer circuit through the understructures 19 and 21. Thus, the integral touch efficiency of the touch panel can be maintained. Therefore, this disclosure increases stability of the touch signal transmission in the touch panel.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A touch panel having a touch area and a peripheral area, comprising:
at least one peripheral line, wherein each peripheral line has a stacking structure and is disposed in the peripheral area surrounding the touch area for transmitting touch signals generated by the touch area.

2. The touch panel of claim 1, wherein the peripheral line comprises an understructure and at least a superstructure, wherein short axial width of the understructure is greater than that of the superstructure.

3. The touch panel of claim 2, wherein discrepancy of the short axial width between the understructure and the superstructure is in a range of 6-10 μm.

4. The touch panel of claim 2, further comprising at least a first axial electrode and at least a second axial electrode disposed in the touch area, and an insulation layer disposed between the first axial electrode and the second axial electrode, wherein the first axial electrode comprises a plurality of first sensing units, and the second axial electrode comprises a plurality of second sensing units.

5. The touch panel of claim 4, wherein the understructure has same composition as the first sensing units and the second sensing units.

6. The touch panel of claim 5, wherein the first sensing units and the second sensing units are composed of transparent conductive materials.

7. The touch panel of claim 4, wherein the first axial electrode further comprises a plurality of first conductive lines connected to the first sensing units, the second axial electrode further comprises a plurality of second conductive lines connected to the second sensing units, and the insulation layer further comprises a plurality of insulation blocks disposed between the first conductive lines and the second conductive lines.

8. The touch panel of claim 7, wherein the superstructure has the same composition as the second conductive lines.

9. The touch panel of claim 8, wherein the second conductive lines are composed of metal materials.

10. The touch panel of claim 1, wherein the touch panel comprises one or more of a capacitive, resistive, infrared ray, acoustic, or optical touch panel.

11. A manufacturing method of a touch panel having a touch area and a peripheral area, comprising:
forming at least a peripheral line, each of which has a stacking structure and is disposed in the peripheral area surrounding the touch area for transmitting touch signals generated by the touch area.

12. The manufacturing method of the touch panel of claim 11, wherein the step of forming the peripheral line comprises:
forming an understructure in the peripheral area; and
forming at least a superstructure on upper surface of the understructure, wherein short axial width of the understructure is greater than that of the superstructure.

13. The manufacturing method of the touch panel of claim 12, wherein discrepancy of the short axial width between the understructure and the superstructure is in a range of 6-10 μm.

14. The manufacturing method of the touch panel of claim 11, further comprising:
forming at least a first axial electrode and at least a second axial electrode in the touch area, wherein the first axial electrode comprises a plurality of first sensing units, and the second axial electrode comprises a plurality of second sensing units; and
forming an insulation layer disposed between the first axial electrode and the second axial electrode.

15. The manufacturing method of the touch panel of claim 14, wherein the understructure has same composition as the first sensing units and the second sensing units.

16. The manufacturing method of the touch panel of claim 15, wherein the first sensing units and the second sensing units are composed of transparent conductive materials.

17. The manufacturing method of the touch panel of claim 14, wherein the first axial electrode further comprises a plurality of first conductive lines connected to the first sensing units, the second axial electrode further comprises a plurality of second conductive lines connected to the second sensing units, and the insulation layer further comprises a plurality of insulation blocks disposed between the first conductive lines and the second conductive lines.

18. The manufacturing method of the touch panel of claim 17, wherein the superstructure has the same composition as the second conductive lines.

19. The manufacturing method of the touch panel of claim 18, wherein the second conductive lines are composed of metal materials.

20. The manufacturing method of the touch panel of claim 15, wherein the steps of forming the understructure, the first sensing units, and the second sensing units are completed simultaneously, and the steps of forming the superstructures and the second conductive lines are completed simultaneously.
